(19) United States
(12) Patent Application Publication
(10) Pub. No.: US 2024/0032648 A1
(43) Pub. Date: Feb. 1, 2024

(54) FOOTWEAR INCLUDING MIDSOLE WITH EMBROIDERED TEXTILE ELEMENT

(71) Applicant: Under Armour, Inc., Baltimore, MD (US)

(72) Inventors: Joan Anderson, Baltimore, MD (US); Eric Zhang, Guangzhou (CN)

(21) Appl. No.: 18/360,339

(22) Filed: Jul. 27, 2023

Related U.S. Application Data
(60) Provisional application No. 63/392,976, filed on Jul. 28, 2022.

(51) Int. Cl. A43B 13/12

(52) U.S. Cl. CPC A43B 13/125

(57) ABSTRACT

A midsole for an article of footwear includes an embroidered structure partially embedded in an exterior surface portion of the midsole. A method of forming the midsole includes combining the embroidered structure with a polymer material in a molding process to form the midsole.

### CROSS-REFERENCE TO RELATED APPLICATION

This application claims priority from U.S. Provisional Patent Application Ser. No. 63/392,976, filed Jul. 28, 2022, the disclosure of which is incorporated herein by reference in its entirety.

### FIELD OF THE INVENTION

The present invention is directed to footwear and, in particular, to an article of footwear with a midsole including an embroidered textile element and a method of forming the article of footwear.

### BACKGROUND

Athletic footwear, such as running shoes, is designed for comfort and durability. Athletic footwear is typically formed of materials having insulating, moisture resistant, and/or abrasion-resistant properties. Typical athletic footwear includes an upper and a sole structure, where the sole structure includes a midsole and an outsole. The midsole and outsole are constructed of materials that provide suitable comfort and cushioning during use of the footwear. A variety of different materials of construction can be used to form the midsole and the outsole of the sole structure to achieve different levels of cushion and durability based upon a particular application.

It would be desirable to provide an article of footwear with enhanced comfort and performance capabilities.

### SUMMARY

The present invention is directed toward a midsole for an article of footwear that includes an embroidered structure partially embedded in an exterior surface portion of the midsole. A method of forming the midsole includes combining the embroidered structure with a polymer material in a molding process to form the midsole.

For example, a method of forming a midsole for an article of footwear comprises combining an embroidered structure with a polymer material within a cavity of a mold, where the embroidered structure comprises crossing yarns that define an open mesh grid pattern for the embroidered structure. The polymer material is subjected to a selected temperature within the mold to form a midsole including the embroidered structure partially embedded in and extending along an exterior surface portion of the midsole.

In another example, an article of footwear comprises an upper, a midsole coupled with the upper at an upper peripheral edge of the midsole, and an outsole coupled with the midsole at a lower peripheral edge of the midsole. The midsole comprises a polymer material and an embroidered structure partially embedded in and extending along a surface of the polymer material that defines an exterior surface portion of the midsole. The embroidered structure comprises crossing yarns that define an open mesh grid pattern for the embroidered structure.

The above and still further features and advantages of the present invention will become apparent upon consideration of the following detailed description of specific embodiments thereof.

### BRIEF DESCRIPTION OF THE DRAWINGS

FIG. 1A is a lateral side view of in perspective of an article of footwear in accordance with embodiments described herein;

FIG. 1B is a lateral side view of the article of footwear of FIG. 1A;

FIG. 1C is a medial side view of the article of footwear of FIG. 1A;

FIG. 1D is a top view in plan of the article of footwear of FIG. 1A;

FIG. 1E is an exploded view of the article of footwear of FIG. 1A;

FIGS. 2A, 2B and 2C are cross sectional views showing formation of rows of crossing yarns to form an embroidered element using embroidery methods in accordance with embodiments described herein;

FIG. 2D is an example embodiment of an embroidered element formed as an open mesh matrix of crossing yarns in accordance with embodiments described herein;

FIG. 3A is another example embodiment of an embroidered element formed as an open mesh matrix of crossing yarns which is incorporated into a midsole of the article of footwear of FIG. 1A in accordance with embodiments described herein;

FIG. 3B is an enlarged view of the embroidered element of FIG. 3A;

FIGS. 3C, 3D and 3E are further enlarged views of portions of the embroidered element of FIG. 3A;

FIG. 4A is a lateral side view of an article of footwear in accordance with other embodiments described herein;

FIG. 4B is a medial side view of the article of footwear of FIG. 4A; and

FIG. 5 is a flowchart illustrating an example method of mold forming a midsole in accordance with embodiments described herein.

Like numerals have been utilized to identify like components throughout the figures.

### DETAILED DESCRIPTION

In the following detailed description, reference is made to the accompanying figures which show, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

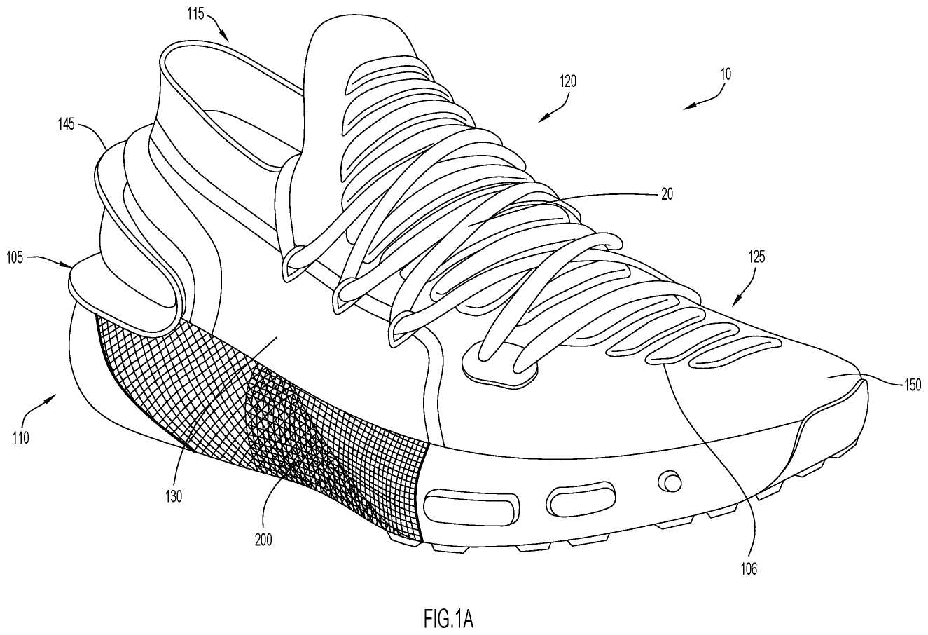

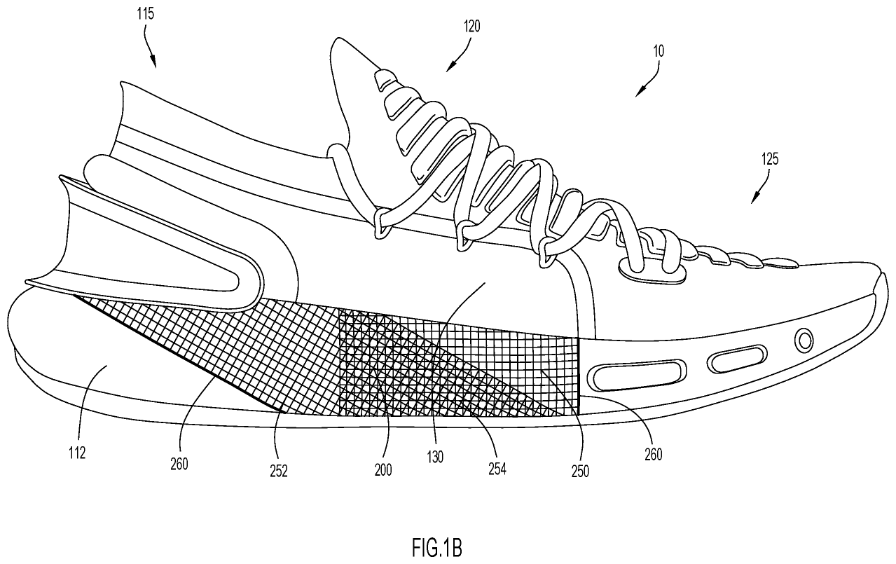

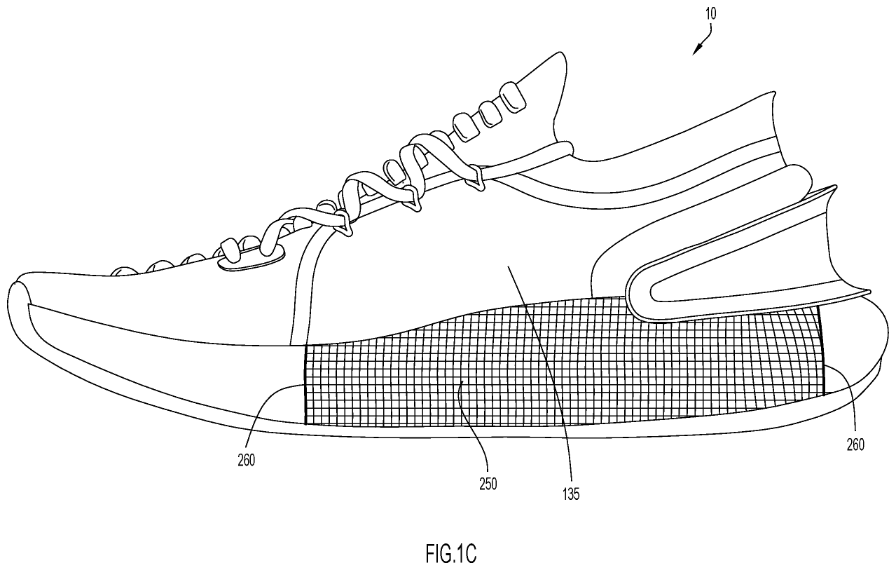

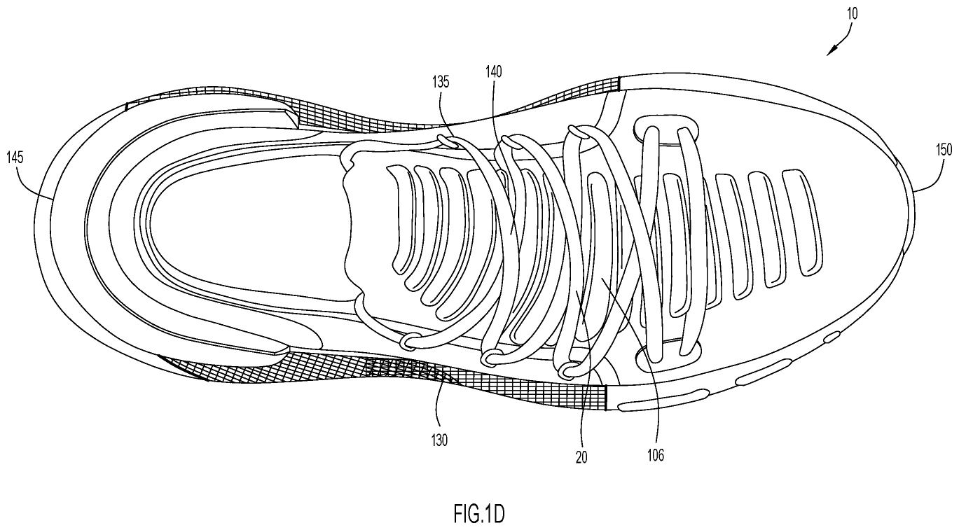

In accordance with embodiments described herein, an example embodiment of an article of footwear 10 or shoe (e.g., athletic shoe) is depicted in FIGS. 1A-1E and includes an upper 105 and a sole structure 110. The sole structure 110 includes a midsole 112 and an outsole 114 (FIG. 1E). The upper 105 is coupled or secured to the midsole 112 at upper portions including an upper peripheral edge 116 of the midsole 112, while the outsole 114 is coupled or secured to the midsole 112 at lower portions including a lower peripheral edge 118 of the midsole 112. An insert 180 (e.g., strobel or midsole insert) can also be provided between the midsole 112 and upper 105. The footwear 10 defines several regions corresponding with various parts of a foot. Specifically, the footwear defines a rear footwear region 115 generally corresponding with the rear of the foot (e.g., the hindfoot including the heel); an intermediate footwear region 120 disposed forward the rear region and generally corresponding to the midfoot (e.g., the arched (instep) and ball areas of the foot); and a forward footwear region 125 disposed forward of intermediate region and generally corresponding to the forefoot (e.g., the toes of the foot).

The shoe 10 further includes a lateral side 130 (FIG. 1B), a medial side 135 (FIG. 1C) and a top side 140 (FIG. 1D) that extends between the lateral and medial sides. The lateral side 130 spans through a longitudinal length of the shoe 10, being configured to extend along the lateral side of the foot. Similarly, the medial side 135 spans a longitudinal length of shoe, being configured to extend along the medial side of the foot. The shoe 10 further includes a rear end or heel side 145 that extends around the heel of the foot and between the lateral and medial sides of the shoe and also a front end or toe side 150 that extends between lateral and medial sides of the shoe and covers the toes of the foot. While the example embodiment depicted in the figures shows an article of footwear (shoe) configured for a right foot, it is noted that the same or similar features can also be provided for an article of footwear (shoe) configured for a left foot (where such features of the left footed shoe are reflection or “mirror image” symmetrical in relation to the right footed shoe).

The upper 105 and sole structure 110 include lateral, medial, heel and toe sides that correspond with the same described for the entire shoe 10. The upper 105 further forms a cavity to receive the foot of a wearer and also includes an instep positioned between the lateral side 130 and the medial side 135, where the instep extends along the instep of the foot of the wearer, and a toe cage that defines the forward area of the upper 105 and configured to house the toes of the wearer's foot. The upper can also include a tongue and lace connections (e.g., eyelets or lace support connections as described herein) that are configured to receive a lace for cinching or tightening the upper (e.g., lateral and medial sides) against the wearer's foot during use of the shoe.

The upper and sole structure (midsole and outsole) can be formed of any conventional or other suitable types of materials for the shoe that provide desired comfort, durability and/or performance characteristics for the shoe. In example embodiments, the upper can comprise one or more textile components comprising a woven material, a nonwoven material, a knit material and/or an embroidered material. When utilizing a textile to form the upper, strands forming the textile can be any one or more fibers, filaments or yarns and can be formed from natural fibers, such as cellulosic fibers (e.g., cotton, bamboo) and protein fibers (e.g., wool, silk, soybean), and/or synthetic (e.g., polymer extruded) fibers formed from one or more polymer materials including, without limitation, polyester, nylon, polypropylene, polyethylene, acrylics, acetate, polyacrylonitrile, and combinations thereof. In addition, the upper can comprise any selected number and types of molded polymer portions, where the upper portions can include polymer materials as described for the upper textiles formed as a laminate or layer (e.g., over a textile layer) and/or formed in a casting or molding process.

The midsole 112 and outsole 114 of the sole structure 110 may each be formed of a single material or plurality of materials. In example embodiments, the midsole may be formed of one or more materials including, without limitation, polyurethane, ethylene vinyl acetate (EVA), an EVA blended with one or more of an EVA modifier, olefins (e.g., olefins such as polyethylene and/or olefin block copolymers that can include, without limitation, C₃-C₂₀ olefins, or C₃-C₁₀ olefins such as propylene, butene, pentene, hexene, heptene and octene), and polyamides. The midsole can be formed of as a foam material, such as a single foam layer or any combination of foam layers (e.g., two, three or more foam layers). In addition, any other layer can be provided between two or more foam layers of a midsole, including a hard plate material (e.g., a nylon plate or a carbon plate). A non-limiting example embodiment of a material that can be used to form some or all of the midsole comprises a portion (e.g., a foam layer) formed of a polyamide polyether copolymer commercially available under the tradename PEBAX (Arkema S.A., France), such as PEBAX RNEW 40R53. Another example embodiment of a material that can be used to form some or all of the midsole comprises a portion (e.g., a foam layer) formed of an olefin block copolymer commercially available under the tradename INFUSE (Dow Chemical Company). The midsole can further include two or more layers that are formed utilizing a process in which a supercritical fluid is combined with a polymer material (e.g., INFUSE) to form a supercritical foam. Example embodiments of midsoles formed that include one or more layers of supercritical foam are described in co-pending application Ser. No. 18/148,569, the disclosure of which is incorporated herein by reference in its entirety.

The outsole may be formed of one or more materials including, without limitation, elastomers (e.g., thermoplastic polyurethane), siloxanes, natural rubber, and synthetic rubber. The outsole, which is the portion of the sole structure that engages the ground surface, is typically formed of a harder, more wear or abrasion resistant material in comparison to the midsole. In particular, the outsole typically has a hardness or durometer value (e.g., as measured on a Shore A durometer scale) that is greater than a hardness or durometer value of the midsole.

One or both of the midsole and the outsole may be formed via a molding process, such as an injection molding process in which one or more liquid or molten polymer materials (such as the previously described materials) are injected into a mold having an internal shape that defines the sole structure components, where the polymer materials are hardened or cured to form a portion (e.g., an entire portion, a half portion, etc.) of the sole structure component. Alternatively, one or both of the midsole and the outsole can be formed by forming (via a molding or other suitable forming process) a blank the midsole or outsole. In particular, the blank can have an initial or starting shape (i.e., prior to being subjected to the forming process) that differs from the final shape of the midsole or outsole being formed from the blank.

As described herein, the midsole includes a textile material that is adhered to lateral and/or medial side portions of the midsole to enhance performance and/or operability features of the midsole. In particular, the textile material can comprise a grid-like, matrix or mesh textile material that is adhered to one or more sides (or portions thereof) of the midsole, where the grid-like material is formed of an embroidered material structure.

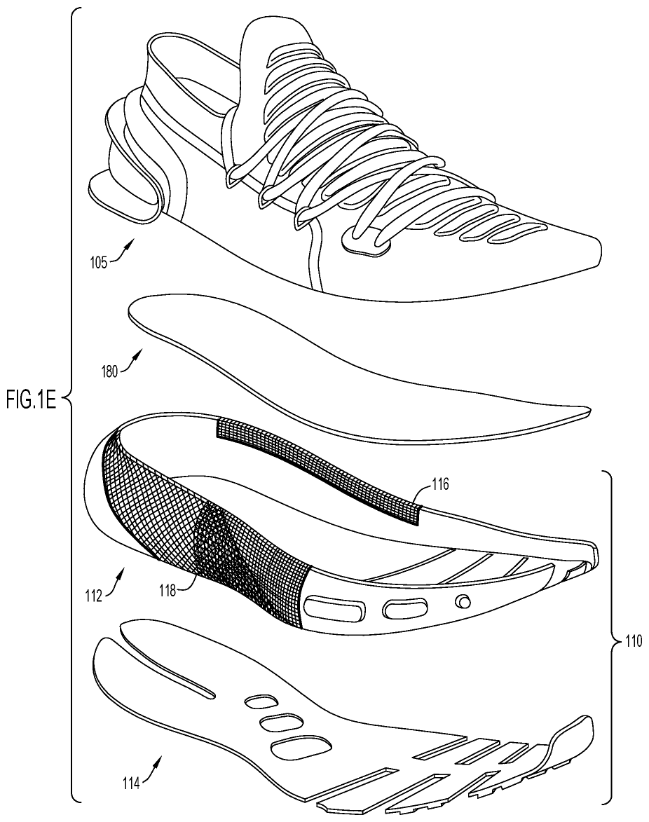

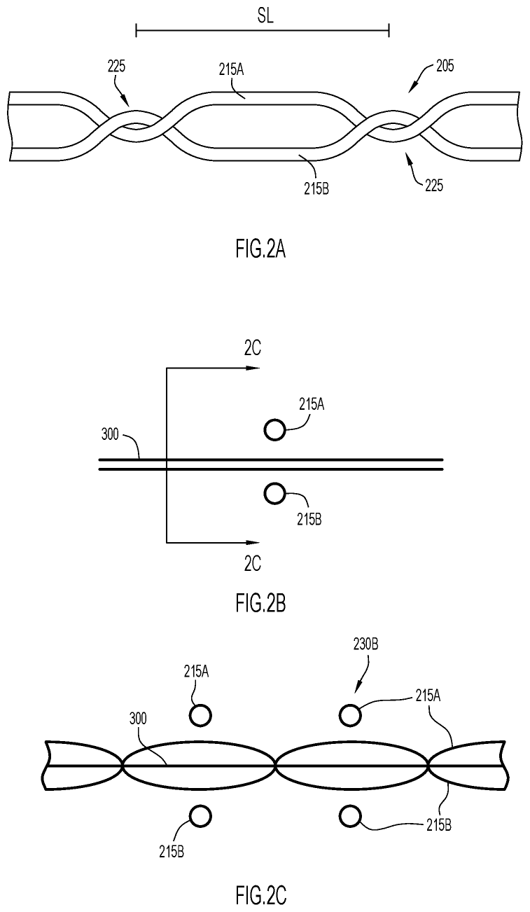

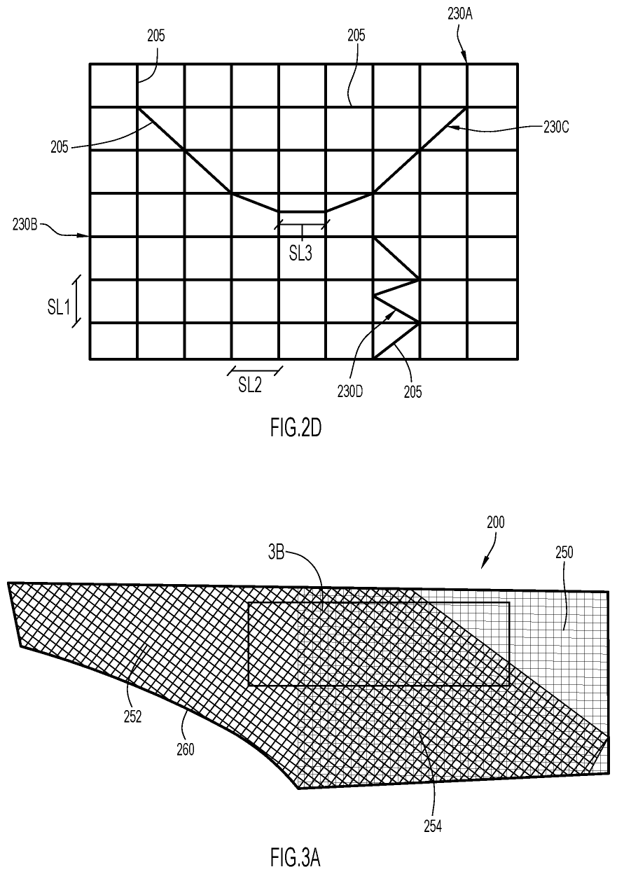

The mesh textile material comprises a yarn matrix embroidered structure formed using an embroidery process which is generally described as follows. The embroidered structure is formed by a plurality of interlocking yarn rows oriented in predetermined directions. Referring to FIGS. 2A, 2B, 2C and 2D, the embroidered structure 200 includes a plurality of crossing rows or crossing yarns 205 (also called binding yarns) oriented in a predetermined pattern (e.g., in rows 230A, 230B, 230C as shown in FIG. 2D). Each crossing row 205 includes a pair of component strands that interlock at selected locations along the length of the row. Specifically, referring to FIG. 2A, a crossing row 205 includes a first or upper (top) strand or thread 215A and a second or lower (bobbin) strand or thread 215B that is generally aligned (e.g., vertically aligned) with the first strand along the length of the row. A strand can include single fiber, filament, or monofilament, as well as an assemblage of textile fibers having a high ratio of length to diameter and normally used as a unit (e.g., includes slivers, roving, single yarns, plies yarns, cords, braids, ropes, etc.). The crossing row 205 includes a first strand 215A and a second strand 215B coupled at selected locations along the length of the row. Specifically, the strands 215A, 215B are coupled via a stitch 225, i.e., an interlocking structure that locks the strands together. By way of example, a lockstitch (where the one strand wraps the other strand) is utilized. A lockstitch effectively secures the strands to each other, preventing unraveling of crossing yarn 205.

While a particular lockstitch is illustrated (an over-lock stitch), it should be understood that different means or types of interlocking may be utilized to provide desired load extension characteristics to the textile structure. For example, other stitches such as a tatami stitch, a triaxial fill stitch, satin stitch, running stitch, chain stitch, etc. may be utilized. In particular, the embroidered structure 200 may be formed via crossing rows 205 utilizing any suitable embroidery apparatus or process, whether by machine or hand. In machine embroidery, a variety of conventional embroidery machines may be utilized to form embroidered structure 200, and the embroidery machines may be programmed to embroider specific patterns or designs from one or a plurality of threads. In general, an embroidery machine forms patterns or designs by repeatedly securing a thread to various locations such that portions of the thread extend between the locations and are visible. Conventional embroidery machines may form patterns or designs on temporary substrate by forming satin-stitches, running-stitches, or fill-stitches, each of which may utilize a lock stitch to secure thread to base layer. Satin stitches are a series of zigzag-shaped stitches formed closely together. Running stitches extend between two points and are often used for fine details, outlining, and underlay. Fill stitches are series of running stitches formed closely together to form different patterns and stitch directions, and fill-stitches are often utilized to cover relatively large areas.

The rows 205—along with the stitches 225 within the rows—may be disposed at any predetermined location along the structure. Typically, the stitches 225 are disposed at regular intervals along the length of the crossing row 205. The distance between adjacent stitches is referred to as the stitch length SL. The strands 215A, 215B are substantially aligned with each other along the stitch length. The stitch length may be any distance suitable for providing desired properties/characteristics of the embroidered structure (e.g., for setting mesh size or size of openings in the embroidered structure as described herein). For example, the stitch length may range from about 0.1 mm to about 5 mm (e.g., 0.5 mm to 4 mm).

By controlling the number of stitches in the crossing yarn 205, the overall stitch density of the embroidered structure 205 may be controlled to affect the overall properties of the structure (and thus conveying desired properties to the midsole). For example, the crossing yarn 205 and/or the self-supporting, embroidered structure 200 may include the same or varying stitch densities, such as a high stitch density which includes a stitch every 0.20 mm-1.50 mm (e.g., 1 mm), a medium density which includes a stitch every 1.60-3.50 mm (e.g., 2 mm), and a low stitch density which includes a stitch every 3.60-5.00 mm (e.g., 4 mm). Accordingly, stitch density refers not only to the density of stitches in a crossing yarn 205, but also the number of stitches in a predetermined area of the embroidered structure 200 (e.g., number of stitches per square millimeter, centimeter, etc.).

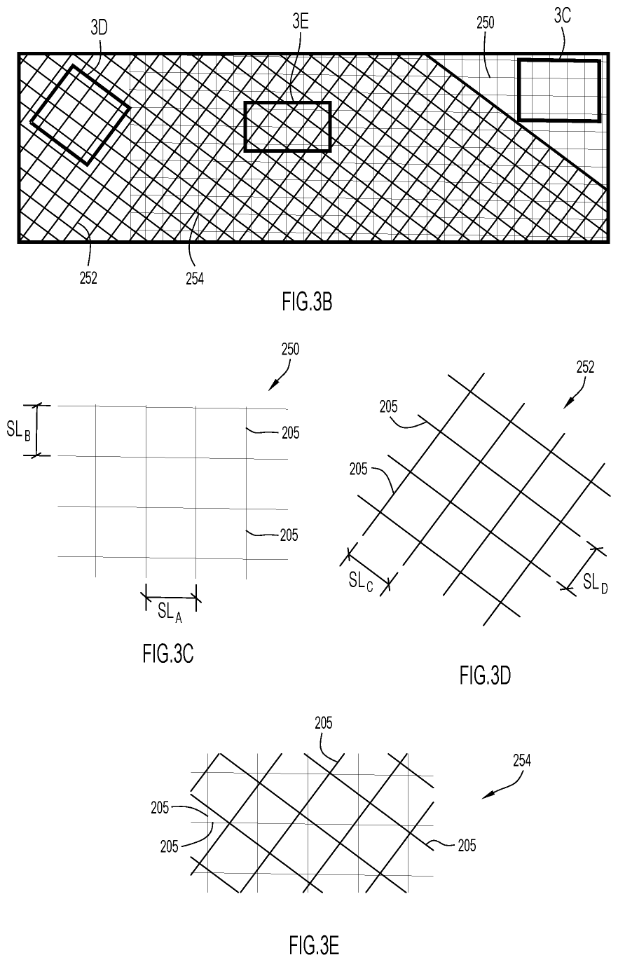

The stitch density and distance between stitches, as well as other features of the yarn (e.g., yarn denier and yarn type), combined with selective placement of one or more embroidered structures along the midsole, can be selected to modify or enhance certain properties of the midsole to which the embroidered structure is secured and thus the properties and performance of the shoe. For example, providing greater stitch densities and smaller spacings between stitches in the embroidered structure can impart a greater stiffness to the midsole which may be useful for certain footwear applications. In contrast, a lower stitch density and greater spacing between stitches within the embroidered structure can impart more flexible (less stiff) properties for the midsole and more dynamic flexing or bending properties for the shoe. Further, coupling or integrating embroidered structures with varying grid patterns including overlapping grid patterns (e.g., as depicted in FIG. 3A, as described in further detail herein) can provide enhanced properties to the midsole and shoe based upon the changing grid patterns (which can also vary the stitch density along such varying grid patterns).

Each crossing row 205 (i.e., each top thread 215A, and bobbin thread 215B) may be formed of any material suitable for its described purpose (i.e., adhering to a portion of the midsole). By way of example, each strand may be formed of nylon, polyester, polyacrylic, polypropylene, polyethylene, metal, silk, cellulosic fibers (e.g., cotton), elastomers, etc. The strands 215A, 215B forming the crossing yarn 205 may be formed of the same or different materials. For example, the first strand 215A may be formed of a first material (e.g., nylon) while the second thread component 215B may be formed of a second material (e.g., polyester). The yarns can further be formed including polymer materials (e.g., elastomers) that provide a certain degree of elasticity to the yarns and resultant embroidered structure formed by the yarns.

In example embodiments, both the first and second strands are formed of a suitably color stable and/or colorfast polymer material, i.e., a polymer material that, when dyed, maintains its color and does not bleed or lose color or fade when subjected to heat (such as being adhered in a mold to a polymer material during formation of the midsole). The polyester (or other polymer) material used to form the strands and the yarn must also have a suitably high melting point to withstand molding temperatures and pressures associated with the midsole molding process as described herein (e.g., temperatures ranging from about 180° C. to about 220° C., e.g., about 200° C.). In a non-limiting example embodiment, both the first and second strands 215A, 215B of some or all of the rows 205 are formed of a cationic dipolyester and/or a solution dipolyester to provide color stability and/or color fastness properties for the yarn. A specific, non-limiting example, of a polymer material that can be used to form the strands and yarns of the embroidery structure (and which yield a desirable color stability/color fastness and have suitable melting point to maintain structural integrity during the midsole forming process) comprises a 100% CDP (cationic dyeable polyester), at least 180 denier, or at least 200 denier (e.g., 210 denier), two filament thread.

In some embodiments, the crossing row 205 may also include a fusible material and/or a non-fusible material. In an embodiment, the crossing row 205 (i.e., one or more strands 215A, 215B of the crossing yarn) may include thermoplastic polymers capable of transitioning to a liquid upon heating to a predetermined melting or glass transition temperature, and then recrystallizing when heat is removed to form a hardened structure (i.e., the crossing yarns are capable of fusing, combining with adjacent fusible materials or encapsulating adjacent non-fusible materials). By way of example, a strand 215A, 215B may be a filament of low-melt material (e.g., low-melt polyester having a melting point of less than 100° C.). By way of further example, the crossing yarn may include a sheath core or double covered yarn, including a sheath or covering of fusible material and a core including non-fusible material.

The diameter of the strands 215A, 215B may be any diameter suitable for their described purpose. By way of example, the strands may be of the same or similar size and can range from about 0.003 mm to about 5 mm (e.g., 0.05 mm to 1 mm) in diameter.

The embroidered structure 200 is formed prior to its combining with material used to form the midsole, where the structure 200 may be formed via an embroidery process in which crossing yarns are selectively fixed to a temporary substrate or base. The temporary substrate 300 (FIGS. 2B and 2C) can be positioned on a frame. The first strand 215A is disposed on a first side of the temporary substrate and the second strand 215B is disposed on a second side of the temporary substrate such that it is generally aligned with the first strand. At predetermined intervals, the second strand 215B passes through the temporary substrate, over the first strand 215A, and back to through the substrate to form a stitch 225. The frame is repositioned and the process continues, forming a row or run along the temporary substrate. The resulting row 205 includes strands 215A, 215B generally aligned on opposite sides of the temporary substrate. Once the innermost crossing yarn rows are formed, additional overstitch or enclosing rows may be stitched into the temporary substrate such that the overstitch strands cross over their related innermost strands. This process may continue to form multiple layers of crossing yarns in the matrix. Once the desired number of rows is created, the temporary substrate can be removed to form an open mesh embroidered structure as shown, e.g., in FIG. 2D.

The embroidered structure 200 may include crossing rows 205 ordered in a predetermined pattern. For example, the crossing yarns 205 may be provided in a matrix including a plurality of intersecting and/or overlapping strands 215A, 215B. Referring again to FIG. 2D, the matrix/structure 200 includes a first line or row or run 230A oriented along a first direction (e.g., generally vertically from the perspective of FIG. 2D) and a second row or run 230B oriented along a second direction (e.g., generally horizontally from the perspective of FIG. 2D). Accordingly, a grid is formed, with the first row 230A being oriented substantially orthogonally to the second row 230B within the matrix.

Additionally, a third row or run 230C oriented along a third direction may be provided. In the example depicted in FIG. 2D, the third row 230C defines a generally arcuate line having a predetermined radius of curvature. As shown, the third row 230C may include segments that bisect the grid blocks defined by the first 230A and second 230B rows. In other words, the third row or run 230C may be oriented at an angle with respect to each of the first row 230A and the second row 230B. In an embodiment, the angle of orientation may fall within the range of about 5° to about 90° (e.g., about 30° to about 60°, such as about 45°). Other rows or runs can also be formed, such as a zig-zag pattern for a fourth row or run 230D as shown in FIG. 2D. The stitch length (SL) between crossing yarns can also vary based upon a particular desired grid pattern to be formed. In the example shown in FIG. 2D, different stitch lengths can be formed between different yarn rows (e.g., SL1 between crossing yarns of yarn rows 230A, SL2 between crossing yarns of yarn rows 230C, and SL3 between crossing yarns of yarn row 230C).

After formation of the embroidered structure on the temporary substrate 300, the substrate 300 can be removed to leave the self-supported open mesh embroidered structure 200. For example, the substrate 300 can be formed of a material that is soluble in a particular solution (e.g., acetone or water). In a non-limiting example, the substrate 300 can comprise a textile material formed of polylactic acid (PLA) which is dissolvable in acetone and also decomposes in water. Decomposition of the PLA base or substrate 300 results in separation and removal of the embroidered structure 200 from the substrate 300 while maintaining the structure 200 intact. This structure is then combined with other polymer materials to form the midsole in the manner described herein.

When utilizing a temporary substrate to form the embroidered mesh structure of crossing rows 205, an elaborate matrix of crossing yarns with a variety of different patterns can be easily formed, where such patterns can be selected based upon a particular application or functionality desired for the structure to apply to the midsole. The patterns can include overlapping grid patterns such as the type described herein and depicted in FIGS. 3A and 3B. Alternatively, other patterns can also be easily formed utilizing the embroidery process as previously described herein. The patterns in the embroidered structure 200 formed by the crossing rows 205 can be formed as overlapping layers of crossing yarns or, alternatively, as a single layer of crossing yarns that extend at varying directions and angles in relation to other crossing yarns.

An embroidered structure 200 for integrating with a midsole is depicted in FIGS. 3A-3E, where the structure 200 comprises a grid pattern with openings formed by a matrix of crossing yarns. This structure 200 is further depicted as part of the midsole 112 for the shoe 10. The embroidered structure 200 comprises a grid overlay that includes a first portion 250, a second portion 252, and a third portion defined by a section of the second portion 252 overlaying the first portion 250.

The first portion 250 is formed of a grid of crossing rows 205 including a plurality of rows of first yarns oriented in a first direction such that the first yarns are parallel with each other and a plurality of rows of second yarns oriented in a second direction and parallel with each other, where the first and second directions are oriented at 90° (i.e. perpendicular) with each other such that the first portion 250 is defined by a rectangular grid pattern formed by intersecting rows of intersecting first and second rows.

Similarly, the second portion 252 is formed of a grid of crossing yarns 205 including a plurality of rows of third yarns oriented in a third direction such that the third yarns are parallel with each other and a plurality of rows of fourth yarns oriented in a fourth direction and parallel with each other, where the third and fourth directions are oriented at 90° (i.e. perpendicular) with each other such that the second portion 252 is defined by a rectangular grid pattern formed by intersecting rows of intersecting third and fourth yarns.

As depicted in FIGS. 3A and 3B, the second portion 252 is formed such that the alignment of its grid pattern is rotationally offset with the grid pattern defined by the first portion 250 by a selected angle such that the second portion 252 is non-parallel and non-perpendicular in relation to the first portion 250. In other words, the third and fourth directions associated with the crossing yarns of the second portion 252 can be rotationally offset in alignment by the selected angle in relation to respective first and second directions associated with the crossing yarns of the first portion 250 such that the third and fourth directions are non-parallel and non-perpendicular in relation to the first and second directions. The selected angle can range from about 20° to about 80°, e.g., from about 30° to about 60°, or about 45° (as depicted in FIGS. 3A and 3B). The combination of first and second portions including grid patterns that are rotationally offset from each other can enhance the effect the embroidered structure imparts to the midsole with regard to stiffness (e.g., due to overlapping grid patterns changing stitch densities of the embroidered structure along the midsole).

The crossing yarns forming the grid patterns for each of the first portion 250 and the second portion 252 can also be of different colors so as to provide a desirable aesthetic look and appearance to the midsole in addition to functional characteristics imparted to the midsole with the embroidered structure incorporated therewith. Yarns formed with suitable color stability/color fastness (such as those previously described herein) will maintain their color after formation of the midsole incorporating the embroidered structure using molding methods as described herein.

As depicted in FIG. 3A, the embroidered element 200 is arranged (i.e., from left to right in the view) so as to correspond with how the embroidered element is oriented on the midsole 112 at the lateral side 130 of the shoe 10 (i.e., left to right direction in the view of FIG. 3A corresponds with heel to toe direction of the midsole and shoe as depicted, e.g., in FIG. 1B). The second portion 252 extends from the end at the left side as shown in FIG. 3A (i.e., from a heel side location of rear footwear region 115 of the shoe 10 when the embroidered structure is integrated with midsole as shown in FIGS. 1A-1E) toward the first portion 250, while the first portion 250 extends from the right side as shown in FIG. 3A (i.e., from a location between the intermediate footwear region 120 and forward footwear region 125 of the shoe 10 when the embroidered structure is integrated with midsole as shown in FIGS. 1A-1E) toward the second portion 252. The second portion 252 and first portion 250 overlap at a central or third portion 254 of the structure 200 so as to define a grid overlay pattern between the grids of the first and second portions which are offset in rotational orientation from each other. As depicted in FIGS. 1A-1E, the central or third portion 254 of the structure 200 can be aligned along the midsole at a location proximate the intermediate footwear region 120 of the shoe 10.

The embroidery methods described herein, in which crossing yarns are first formed utilizing a temporary base or substrate (e.g., formed with a dissolvable or decomposing textile material) followed by removal of the temporary substrate, facilitates the formation of any suitable types of grid patterns of crossing/intersecting yarns, including the grid patterns that combine to form the embroidered structure 200 of FIG. 3A via any suitable number of layers (e.g., one layer, two layers, n layers). For example, the embroidered structure 200 of FIG. 3A, including first, second and third portions 250, 252, 254, can be formed in which crossing yarns defining different grid patterns combine together in a single embroidered layer. Alternatively, the embroidered structure 200 can be formed as a first layer comprising the first portion 250 and a second layer comprising the second portion 252, where the first and second layers overlap (e.g., second layer overlaps first layer) to form the third portion 254 of overlaying grid patterns. The overlap and/or combining of grid patterns at the third portion can enhance the effect of the embroidered structure in imparting desired features to the midsole (e.g., flexibility/stiffness, structural support, etc.) in comparison to providing a single grid pattern for an embroidered structure coupled with the midsole.

As further depicted in FIG. 3A, the embroidered structure 200 includes a peripheral edge or border 260 surrounding the structure that is formed of a plurality of yarns to provide a thicker peripheral edge in relation to the interior grids of crossing rows 205. This border 260 locks in the crossing yarns 205 within the embroidered structure and prevents unraveling and/or fraying that might otherwise occur at the edges. This further facilitates an enhanced securing or integration with the polymer material during formation of the midsole (e.g., via injection or compression molding as described herein, where the border of the structure enhances placement and holding alignment of the structure against the midsole surface within the mold). As is indicated in the figures, at least one peripheral edge or border 260 of the embroidered structure 200 is exposed or visible along the midsole of the shoe (e.g., side peripheral edges that extend from lower peripheral edge 118 toward upper peripheral edge 116 of the embroidered structure 200).

The embroidered structure 200 can further be formed such that the openings in the mesh or grid matrix defined by the crossing rows 205 for each of the first portion 250 and the second portion 252 have any suitable size(s) (e.g., a single uniform mesh opening size or a range of different mesh opening sizes). Referring to FIGS. 3C and 3D, the dimensions of the mesh openings of the first portion 250 are defined by stitch lengths SL_{A} and SL_{B} located between consecutive pairs of first yarns and consecutive pairs of second yarns, while the dimensions of the mesh openings of the second portion 252 are defined by stitch lengths SL_{C} and SL_{D} located between consecutive pairs of third yarns and consecutive pairs of fourth yarns. The stitch lengths SL_{A} and SL_{B} can be the same size (forming square shaped openings) or different sizes (forming rectangular openings). Similarly, the stitch lengths SL_{C} and SL_{D} can be the same size (forming square shaped openings) or different sizes (forming rectangular openings). In addition, each of the stitch lengths SL_{A}, SL_{B}, SL_{C} and SL_{D} can be the same or different sizes. The sizing of the openings in the mesh grid patterns for the structure 200 can be selected to impart selected properties for the midsole for a particular use of the shoe.

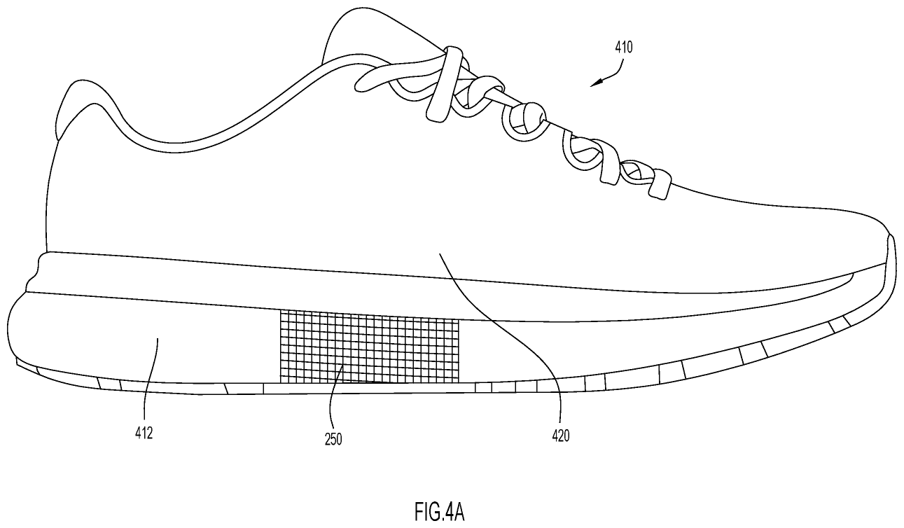

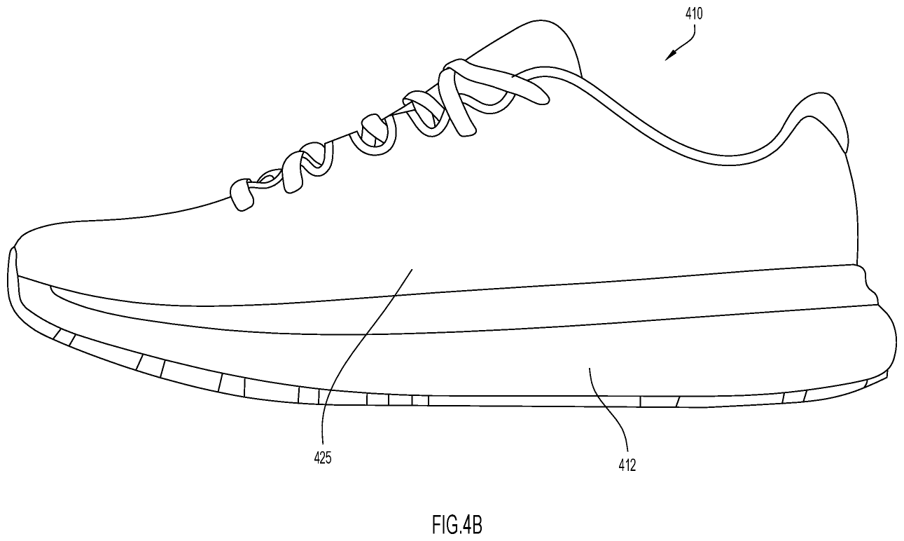

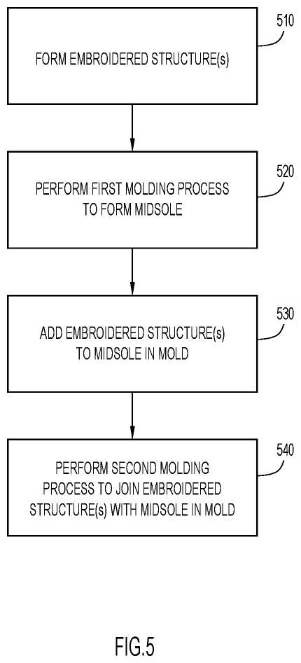

As previously noted, and as shown in the Figures, the embroidered structure 200 is provided on the midsole at a location that extends along a portion (e.g., some or all) of the lateral side of the shoe 10. An embroidered structure having the same of similar pattern can also be provided on the midsole along a portion (e.g., some or all) of the medial side of the shoe. Alternatively, the medial side of the midsole can be provided with an embroidered structure having a different pattern in relation to the lateral side. Further still, one side (e.g., lateral side or medial side) of the midsole can be configured to include no embroidered structure. As can be seen from the figures of the previously described embodiment (e.g., FIG. 1C), the medial side 135 of the shoe 10 and upper 112 includes an embroidered structure that includes a single first portion 250 that is substantially similar to the first portion 250 at the lateral side. However, the medial side does not include the second portion 252. In a further embodiment depicted in FIGS. 4A and 4B, a shoe 410 includes a midsole 412 with an embroidered structure comprising a first portion 250 (single grid pattern) at the lateral side 420 of the shoe that is substantially similar to the first portion 250 of shoe 10, while the medial side 425 of the shoe 410 has no embroidered structure secured to the midsole 412.

The embroidered structure can further be formed to wrap around the entire periphery (including lateral and medial sides, and toe and heel sides) of the midsole or, alternatively, along only selected portions of the midsole (e.g., as depicted in the embodiments of FIGS. 1 and 4). Portions of the embroidered structure can further wrap around the top or upper peripheral edge 116 of the midsole and/or around a bottom or lower peripheral edge 118 of the midsole 112. For example, a portion of the embroidered structure can be folded over and around an upper peripheral edge portion of the midsole prior to coupling or connecting an upper with the midsole upper end (see, e.g., FIG. 1E). Similarly, a portion of the embroidered structure can also be folded over and around a lower peripheral edge portion of the midsole prior to coupling or connecting an outsole to the midsole lower end. When wrapping the embroidered structure around the midsole in this manner, the embroidered structure extends along portions of the midsole from a lower midsole peripheral edge 118 that is adjacent the outsole to the upper midsole peripheral edge 116 that is adjacent the upper (e.g., as can be seen in FIGS. 1 and 4).

A method of forming a midsole with embroidered structure(s) integrated with the midsole is now described with reference to the flowchart of FIG. 5 as well as preceding FIGS. 1-4. At 510, one or more embroidered structures 200 are formed in a manner as previously described, where a self-supported, mesh-like textile element is formed via embroidering crossing yarns in one or more patterns (e.g., overlaid grid patterns as depicted in FIG. 3A) on a temporary substrate followed by dissolution or decomposition of the temporary substrate from the crossing yarns. Further, each embroidered structure includes peripheral boundaries or borders formed from multiple runs of yarns (i.e., a plurality of yarns combined to provide a thicker, strand at the borders surrounding the structure). Any selected number of embroidered structures can be provided having different patterns of crossing yarns, with each embroidered structure being formed having suitable dimensions to accommodate a specified fit and coverage along a portion of lateral and/or medial sides (and/or heel and/or toe sides) of the midsole based upon a particular application or purpose.

At 520, a first molding process is performed to form the midsole. The mold is hollow and can have a clam shell or any other suitable configuration that facilitates opening and access to a cavity disposed within the mold, where the cavity defines an internal wall contour that defines the shape and dimensions of the midsole to be formed therein. The midsole mold can be configured to form the midsole via an injection molding process, where molten or liquid polymer material is injected into the cavity of the mold and then heat set or cured to solidify and form the midsole. In another embodiment, a preform or a blank of polymer material can be provided within the mold cavity, where the mold is configured to perform a compression molding process in which the blank is subjected to a suitable temperature and a suitable pressure to shape and form the midsole from the blank having a desired shape and dimensions. The preform or blank can have a general shape that is formable within the mold such that it changes in shape to the desired midsole shape after being subjected to the compression molding process. The molding temperature required to form the midsole via injection or compression molding can range from about 180° C. to about 220° C. (e.g., about 200° C.), where the first molding process time can be around 200 seconds. Pressure ranges during the molding process can vary significantly depending upon whether an injection molding process or a compression molding process is performed.

At 530, one or more embroidered structures (e.g., an embroidered structure on one or both of the lateral and medial sides of the shoe) are provided within the mold that includes the midsole formed during the first molding step. The one or more embroidered structures can be placed at selected locations along the midsole and within the mold that is configured to form the midsole for the shoe. A suitable adhesive (e.g., polyurethane) can be used to secure each embroidered structure to the surface of the midsole within the mold. Alternatively, and depending upon the tackiness or softness of the midsole within the mold (e.g., if the midsole is not entirely hardened or cured after the first molding step), each embroidered structure can also be pressed against the midsole within the mold and adhered at the midsole surface without the requirement of adhesive. As previously noted, portions of the embroidered structure can be wrapped around portions of the upper and lower midsole peripherals edges during positioning of the embroidered structure against the midsole.

At 540, a second molding process is performed with the midsole and embroidered structure(s) within the mold to join or secure the embroidered structure(s) with the midsole. The temperature for the second molding process can be similar to the first molding process and can range from about 180° C. to about 220° C. (e.g., about 200° C.), where the second molding process time can also be around 200 seconds.

During the second molding process, polymer material from the midsole can flow or extend slightly into the openings of the mesh grid pattern(s) of embroidered structures such that the finished midsole includes the embroidered structure(s) partially embedded within the polymer material. In other words, the crossing yarns of the embroidered structure can sink or embed partially into outer surface portions of the midsole during the second molding process (e.g., the crossing yarns can embed no more than 50% of their diameters and along their lengths within the midsole at the outer surface portions of the midsole), while the remainder of the crossing yarns remain exposed or exterior to the outer surface portions of the midsole. This is particularly the case when the midsole is formed as a foam material. Folding over of a portion of each embroidered structure along a bottom surface portion and/or a top surface portion of the midsole being formed can be achieved by suitable placement of a portion of each embroidered structure within the mold cavity such that portions of the structure are folded, e.g., from a lateral or medial side and onto top and/or bottom surface portions of the midsole being formed in the mold. The partial embedding of each embroidered structure within the midsole integrates the embroidered structure as part of the midsole and significantly limits or prevents its removal from the midsole when the midsole is integrated as part of the shoe as well as during use of the shoe.

As a result of the midsole forming process, each embroidered structure 200 can be affixed or secured to the midsole at a specific location along the midsole surface, where one or more peripheral edges or borders 260 of the structures 200 are exposed (i.e., visible) along the midsole and further contain the crossing yarns within each structure (i.e., crossing yarns cannot unravel or fray at the borders). The thickness of each border 260 also provides an effective alignment guide for placing an embroidered structure 200 against the midsole at precise locations. In some embodiments, the midsole can be formed in the first molding step so as to include one or more slight linear indentations or grooves along one or more surface portions (e.g., outer surface portions) of the midsole that provide an alignment feature for precisely aligning an embroidered structure with the midsole in the second molding step by placing a border 260 of the embroidered structure 200 along a corresponding groove at such surface portion of the midsole.

In other example embodiments of forming the midsole, the embroidered structure(s) can first be placed within a mold, followed by providing polymer material within the mold to form the midsole including embroidered structure(s) joined or combined with the midsole. For example, in an injection molding process used to form the midsole, one or more embroidered structures can be placed in the mold cavity when the mold is opened at one or more suitable locations that correspond with surfaces of the midsole that is formed within the mold. The mold can then be closed and polymer injected within the mold to form the midsole. In the injection molding process, the polymer flows against the embroidered structures and adheres the embroidered structures against the midsole as the polymer is cured and hardened within the mold. A similar process can also be performed when utilizing a blank to form the midsole in a compression molding process.

Incorporation of an embroidered structure with exterior sidewall portions of the midsole for the shoe (e.g., lateral side and/or medial side) can provide enhanced operability and performance characteristics for the midsole during use of the shoe. For example, the crossing yarns forming the embroidered structures can be formed of any suitable materials suitable for a particular purpose. As previously noted, the yarns can comprise polymer materials that are sufficiently heat stable (sufficiently high melting points) to withstand the temperatures and pressures of a midsole molding process while also maintaining suitable color fastness/color stability of any dyes provided in the yarns. Yarns of different portions of an embroidered structure (e.g., first portion 250 and second portion 252 for the structure 200 depicted in FIG. 3) can by dyed with different colors to provide grid patterns along the midsole having a unique and desirable aesthetic quality. For example, two or more yarns forming one or more grid patterns of the embroidered structure can be dyed with one or more suitable dyes to be imparted with two or more different colors, where the dyes maintain color (i.e., are colorfast) over a temperature of the molding process used to form the midsole (e.g., temperatures ranging from about 180° C. to about 220° C., such as 200° C.). As noted herein, 100% CDP (cationic dyeable polyester) yarns can be provided that will withstand the molding temperatures for forming the midsole. In a specific example, first portion 250 can include yarns having a first color while second portion 252 can include yarns having a second color that differs from the first color, where both the first and second colors are imparted to the yarns via suitable dyes that are stable and maintain color (i.e., are colorfast, will not fade or lose color) over the desired temperature range (e.g., range of temperatures that the embroidered structure may be exposed to during the midsole molding/forming process).

The yarns may be combined in a selected manner to modify or enhance properties of the midsole 112 and/or the shoe 10 including, without limitation, stretch, stretch-resistance, shock-absorbance, wear-resistance, etc. The yarns used to form the embroidered structures integrated with the midsole may also be configured (based upon polymer materials used to form the yarns) to provide other properties such as electrically conducting, self-cleaning, thermally regulating and insulating, flame resistant, and/or UV-absorbing. Certain embroidered structures can also be formed including fusible yarns that soften when exposed to heat of a predetermined temperature, and harden once cooled (e.g., at ambient conditions). Fusible yarns can be formed of thermoplastic polymer material, such as polyurethane, nylon, polyester, and polyolefin. Fusible yarns may also include a mixture of a thermoplastic yarn and polyester or nylon. The structure of such yarns may include a thermoplastic yarn surrounded by a non-thermoplastic yarn, a non-thermoplastic yarn surrounded by thermoplastic yarn, and/or a combination of thermoplastic and non-thermoplastic yarns. After being heated to the melting temperature, the thermoplastic yarn fuses with the non-thermoplastic yarn (e.g., polyester or nylon), stiffening the embroidered material so as to impart a protective covering over surfaces of the midsole and/or other desired properties to the midsole when integrated into the shoe.

Shoes or athletic footwear that include midsoles with embroidered textile structures integrated therewith can be for any type of use including, without limitation, running shoes, baseball shoes, basketball shoes, cross-training shoes, cycling shoes, football shoes, tennis shoes, soccer shoes, walking shoes, and hiking boots, etc. Shoes incorporating such midsoles may further include non-athletic styles such as dress shoes, loafers, sandals, etc.

In addition to the embroidered structure integrated midsole features, the shoe 10 can also be provided with further features that can enhance its operability and performance characteristics. For example, referring to FIGS. 1A and 1D, the upper 105 can include raised structures, ribs or beams 106 that extend along the intermediate footwear region 120 and forward footwear region 125 of the shoe 10 (e.g., from a tongue portion to the toe cage portion of the upper). The beams 106 can be formed as thickened portions of material of the upper at their respective locations. The raised structures, ribs or beams 106 can further be aligned in a generally parallel manner with each other and spaced a suitable distance from each other, where each beam 106 extends in a direction between the lateral side 130 and the medial side 135 of the upper. Thus, the surface of the upper including the beams can have a rolling or undulating contour, with the beams 106 forming elevated “hills” and spaces between the beams forming “valleys” in the undulating contour. The beams 106 can be of the same or similar lengths. Alternatively (and as shown, e.g., in FIGS. 1A and 1D), the beams 106 can vary in length (e.g., decreasing in length in a direction toward a terminal end of the tongue and/or in a direction toward the toe cage, such that the centrally located beams are greatest in length).

As also shown in FIGS. 1A and 1D, a lace 20 extends in a criss-cross pattern between lateral and medial sides of the upper so as to lace through eyelets on the upper in order to facilitate effective tightening or cinching of the upper lateral and medial sides together when the shoe is worn. The beams 106 can be suitably dimensioned and spaced from consecutively aligned beams so as to permit a portion of the lacing 20 of the shoe 10, as it crosses between lateral and medial sides of the upper, to be received or fit in the spacing between two consecutive beams. This can have the effect of enhancing tightening of the upper around the foot of the wearer by the lacing 20. In addition, yarns or other material used to form the upper at the location of and including the beams can be formed of one or suitable polymers having certain thermal properties that enhance heat transfer from the interior cavity of the upper to the upper exterior surface, where the beams function as heat transfer fins for the upper.

Thus, the midsole with integrated embroidered structure can provide enhanced performance characteristics of the shoe in which the midsole is integrated. In addition, the upper features as described herein can further enhance performance characteristics of the shoe.

While the invention has been described in detail and with reference to specific embodiments thereof, it will be apparent to one skilled in the art that various changes and modifications can be made therein without departing from the spirit and scope thereof.

It is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

What is claimed:

1. A method of forming a midsole for an article of footwear, the method comprising:
combining an embroidered structure with a polymer material within a cavity of a mold, wherein the embroidered structure comprises crossing yarns that define an open mesh grid pattern for the embroidered structure; and
subjecting the polymer material to a selected temperature within the mold to form a midsole including the embroidered structure partially embedded in and extending along an exterior surface portion of the midsole.

2. The method of claim 1, wherein the midsole is formed by:
placing the embroidered structure within the cavity of the mold; and
injecting the polymer material into the cavity of the mold including the embroidered structure so as to form the midsole with embroidered structure partially embedded in and along the exterior surface portion of the midsole.

3. The method of claim 1, wherein the midsole is formed by:
placing the embroidered structure and a blank comprising the polymer material within the cavity of the mold; and
subjecting the embroidered structure and the blank to a compression molding process within the mold to form the midsole with embroidered structure partially embedded in and along the exterior surface portion of the midsole.

4. The method of claim 1, wherein the midsole is formed by:
performing a first molding process to form the midsole from the polymer material; and
after performing the first molding process, placing the embroidered structure in the cavity of the mold including the midsole; and
performing a second molding process to form the midsole with embroidered structure secured to the midsole.

5. The method of claim 4, wherein the embroidered structure is placed in the cavity of the mold along a surface of the midsole such that a peripheral border along a side of the embroidered structure aligns with a corresponding groove along the surface of the midsole.

6. The method of claim 1, wherein the embroidered structure is placed in the cavity of the mold along a surface of the midsole such that a peripheral border along a side of the embroidered structure is visible along a surface of the mid sole after performing the midsole including the embroidered structure partially embedded in and extending along an exterior surface portion of the midsole.

7. The method of claim 1, wherein the selected temperature is from about 180° C. to about 220° C.

8. The method of claim 1, wherein the yarns of the embroidered structure comprise cationic dyeable polyester yarns.

9. The method of claim 1, wherein the midsole is formed with the embroidered structure being partially embedded along the exterior surface portion of the midsole that defines a portion of a lateral side of the article of footwear when the midsole is incorporated with the article of footwear.

10. The method of claim 1, wherein a first portion of the embroidered structure comprises a first grid of crossing yarns including a plurality of rows of first yarns oriented in a first direction and parallel with each other and a plurality of rows of second yarns oriented in a second direction and parallel with each other, and the first direction is perpendicular to the second direction.

11. The method of claim 10, wherein a second portion of the embroidered structure comprises a second grid of crossing yarns including a plurality of rows of third yarns oriented in a third direction and parallel with each other and a plurality of rows of fourth yarns oriented in a fourth direction and parallel with each other, the third direction is perpendicular to the fourth direction, and the third and fourth directions are non-parallel and non-perpendicular in relation to the first and second directions.

12. The method of claim 11, wherein the third direction of third yarns is offset at a selected angle from the first direction of first yarns, and the selected angle ranges from about 30° to about 60°.

13. The method of claim 12, wherein the selected angle is about 45°.

14. The method of claim 11, wherein a third portion of the embroidered structure comprises an overlay of the first grid of crossing yarns of the first portion with the second grid of crossing yarns of the second portion.

15. The method of claim 14, wherein the first portion of the embroidered structure comprises a first layer, the second portion of the embroidered structure comprises a second layer, and the third portion comprises a portion of the second layer that overlaps a portion of the first layer.

16. The method of claim 14, wherein the first portion, the second portion and the third portion are formed as a single layer of crossing yarns defining the first grid and the second grid.

17. A method of forming an article of footwear, comprising:
providing the midsole formed by the method of claim 1;
coupling an outsole with the midsole at a lower peripheral edge of the midsole; and
coupling an upper with the midsole at an upper peripheral edge of the midsole.

18. The method of claim 17, wherein the embroidered structure extends over a portion of at least one of the lower peripheral edge and the upper peripheral edge of the midsole.

19. An article of footwear comprising:
an upper;
a midsole coupled with the upper at an upper peripheral edge of the midsole; and
an outsole coupled with the midsole at a lower peripheral edge of the midsole;
wherein the midsole comprises a polymer material and an embroidered structure partially embedded in and extending along a surface of the polymer material that defines an exterior surface portion of the midsole, wherein the embroidered structure comprises crossing yarns that define an open mesh grid pattern for the embroidered structure.

20. The article of footwear of claim 19, wherein:
a first portion of the embroidered structure comprises a first grid of crossing yarns including a plurality of rows of first yarns oriented in a first direction and parallel with each other and a plurality of rows of second yarns oriented in a second direction and parallel with each other, and the first direction is perpendicular to the second direction;
a second portion of the embroidered structure comprises a second grid of crossing yarns including a plurality of rows of third yarns oriented in a third direction and parallel with each other and a plurality of rows of fourth yarns oriented in a fourth direction and parallel with each other, the third direction is perpendicular to the fourth direction, and the third and fourth directions are non-parallel and non-perpendicular in relation to the first and second directions; and
a third portion of the embroidered structure comprises an overlay of the first grid of crossing yarns of the first portion with the second grid of crossing yarns of the second portion.

21. The article of footwear of claim 20, wherein the third direction of third yarns is offset at a selected angle from the first direction of first yarns, and the selected angle ranges from about 30° to about 60°.

22. The article of footwear of claim 19, wherein a peripheral border along a side of the embroidered structure is visible along a surface of the midsole.

23. The article of footwear of claim 19, wherein the yarns of the embroidered structure comprise cationic dyeable polyester yarns.
